(19) United States
(12) Patent Application Publication
(10) Pub. No.: US 2003/0174869 A1
(43) Pub. Date: Sep. 18, 2003

(54) Image processing apparatus, image processing method, program and recording medium

(76) Inventor: Anthony P. Suarez, Tokyo (JP)

Correspondence Address: FISH & RICHARDSON P.C., 45 ROCKEFELLER PLAZA, SUITE 2800, NEW YORK, NY, 10111, US

(21) Appl. No.: 10/386,730

(22) Filed: Mar. 12, 2003

(30) Foreign Application Priority Data
Mar. 12, 2002 (JP) 2002-067566
Aug. 8, 2002 (JP) 2002-231996

(51) Int. Cl. G06K 9/00

(52) U.S. Cl. 382/118; 382/164

(57) ABSTRACT

An image processing apparatus and the like which detect particular regions (e.g., facial regions) from an image and so forth are provided. The image processing apparatus detects skin-colored regions from an input image. Then, it detects regions larger than a particular size from among the detected skin-colored regions. Then, it detects regions which have particular holes out of the detected regions larger than a particular size as facial regions. Then, it determines the orientation of the image by analyzing the detected facial regions. Then, it generates an image for masking the detected facial regions. Then, it lays out an inputted object on the image taking into consideration the facial regions and the orientation of the image.

This application claims priority from Japanese Patent Application Nos. 2002-067566 and 2002-231996 filed Mar. 12, 2002 and Aug. 8, 2002, respectively, which are incorporated hereinto by reference.

### BACKGROUND OF THE INVENTION

1. Field of the Invention

The present invention relates to image processing and feature extraction. More particularly, it relates to an image processing apparatus and the like which detect particular regions (e.g., facial regions) from an image and so forth.

2. Description of the Related Art

Face recognition has been attracting growing interest in the fields of artificial intelligence and biometrics. One of the basic steps in face recognition is face detection. Faces in a single image or in a series of images such as a video sequence are detected through a variety of techniques.

An invention by Baluja (U.S. Pat. No. 6,128,397) classifies images to those which include faces and those which do not include faces through sub-sampling and statistical processing of the sub-sampled images using neural networks.

An invention by Souma (U.S. Pat. No. 5,901,244) describes a feature extraction system as the front end of a face recognition system. Feature extraction employs so-called eigen vectors which are commonly used in principal component analysis.

However, conventional face recognition and image processing leave something to be desired.

FIG. 1 is a diagram showing an example of an image (image 92). Suppose text reading “Hello everyone. Check out the view from Mt. Fuji” is laid out on image 92.

FIG. 2 is a diagram showing an example of an image on which the text is laid out. In the example of FIG. 2, the text is overlapping with the face, impairing the image.

Also, unless the orientation (which side is up, etc.) of the image is known in advance, it is not possible to lay out text on the image in such a way that the text will be oriented properly with respect to the image.

FIG. 3 is a diagram showing an example of an image. The image contains facial regions 81 and 82, background regions 83 and 84, and clothing regions 85 and 86. Now, let's consider how to detect the facial regions 81 and 82 from the image. The facial region 81, facial region 82, background region 83, background region 84, and clothing region 86 excluding the collar are similar to each other in color to some extent.

FIGS. 4 to 6 are diagrams showing examples of facial regions detected from the image of FIG. 3. The facial regions detected may be the facial regions 81 and 82 as shown in FIGS. 4 and 5 or a facial region 81′ as shown in FIG. 6. Detection of facial regions will be generally satisfactory if the facial regions 81, 81′, and 82 shown in FIGS. 4 to 6 can be detected. In the following description, consideration will be given to detecting the facial regions 81 and 82.

In the example of FIG. 3, the facial region 81 is generally more difficult to detect than the facial region 82. This is because whereas the facial region 82 is surrounded by hair and a collar which differ greatly from the skin in color, the facial region 81 is similar to the background region 83 in color with no clear boundary between them. Consequently, even if an attempt is made to detect the facial region 81 alone, it may be detected together with the background region 83. It is also difficult for prior art to detect the facial region 81.

### SUMMARY OF THE INVENTION

Thus, an object of the present invention is to detect particular regions (e.g., facial regions) from an image.

Another object of the present invention is to lay out an object (e.g., text) on an image in such a way that the object will not overlap with particular regions.

Another object of the present invention is to lay out an object on an image in such a way that the object will be oriented properly with respect to the image.

Another object of the present invention is to allow particular regions (e.g., facial regions) to be detected properly from an image.

To achieve the above objects, in a first aspect of the present invention, there is provided an image processing apparatus comprising: means for storing detection information for detecting a particular region from an image; means for accepting input or selection of the image; and means for detecting the particular region from the image using the detection information.

Here, the particular region may be a facial region.

Here, the detection information may include information about a skin color and the means for detecting the particular region may comprise means for detecting a skin-colored region from the image.

Here, the detection information may include information about a size and the means for detecting particular regions may comprise means for detecting a region larger than a particular size from among skin-colored regions.

Here, the detection information may include information about holes and the means for detecting particular regions may comprise means for detecting a region which has particular holes from among skin-colored regions.

Here, the means for detecting a region which has particular holes may comprise means for performing edge detection.

Here, the detection information may include information about an eye or mouth color and the means for detecting a region which has particular holes may comprise means for judging whether regions which correspond to the particular holes in the image have an eye or mouth color.

Here, the image processing apparatus may comprise means for analyzing the particular region and determining orientation of the image.

Here, the image processing apparatus may comprise means for generating an image which masks the particular region.

Here, the image processing apparatus may comprise means for accepting input or selection of an object, and means for laying out the object on the image in such a way that the object will not overlap with the particular region.

Here, the image processing apparatus may comprise means for analyzing the particular region and determining orientation of the image, means for accepting input or selection of an object, and means for laying out the object on the image in such a way that the object will be oriented properly with respect to the image.

In a second aspect of the present invention, there is provided an image processing method for an image processing apparatus which comprises means for storing detection information for detecting a particular region from an image, the method comprising the steps of: accepting input or selection of the image; and detecting the particular region from the image using the detection information.

In a third aspect of the present invention, there is provided a program for causing an image processing apparatus which comprises means for storing detection information for detecting a particular region from an image to execute an image processing method, the method comprising the steps of: accepting input or selection of the image; and detecting the particular region from the image using the detection information.

In a fourth aspect of the present invention, there is provided a computer-readable recording medium recording a program for causing an image processing apparatus which comprises means for storing detection information for detecting a particular region from an image to execute an image processing method, the method comprising the steps of: accepting input or selection of the image; and detecting the particular region from the image using the detection information.

In a fifth aspect of the present invention, there is provided an image processing apparatus comprising: means for accepting input or selection of a first image; means for detecting edges from the first image; and means for generating a second image by converting colors of pixels which correspond to the detected edges into a particular first color in the first image.

Here, the image processing apparatus may further comprise means for converting the first image into a third image in grayscale, wherein the means for detecting detects edges from the third image.

Here, the image processing apparatus may further comprise means for detecting pixels which have a particular second color from the first image and generating a fourth image composed of the detected pixels, wherein the means for generating the second image generates the second image by converting colors of pixels which correspond to the detected edges into the first color in the fourth image.

Here, the second color may be a skin color and the first color may be a color other than the skin color.

Here, the image processing apparatus may further comprise means for detecting a facial region from the second image.

Here, the image processing apparatus may further comprise means for accepting input or selection of an object, and means for laying out the object on the first image in such a way that the object will not overlap with a region which corresponds to the detected facial region in the first image.

In a sixth aspect of the present invention, there is provided an image processing apparatus comprising: means for accepting input or selection of a first image; means for detecting pixels whose brightness is lower than a particular threshold out of pixels in the first image; and means for generating a second image by converting colors of pixels which correspond to the detected pixels into a particular first color in the first image.

Here, the image processing apparatus may further comprise means for converting the first image into a third image in grayscale, wherein the means for detecting detects pixels whose brightness is lower than the threshold out of pixels in the third image.

Here, the image processing apparatus may further comprise means for detecting pixels which have a particular second color from the first image and generating a fourth image composed of the detected pixels, wherein the means for generating the second image generates the second image by converting colors of pixels which correspond to the detected pixels into the first color in the fourth image.

Here, the second color may be a skin color and the first color may be a color other than the skin color.

Here, the image processing apparatus may further comprise means for detecting a facial region from the second image.

Here, the image processing apparatus may further comprise means for accepting input or selection of an object, and means for laying out the object on the first image in such a way that the object will not overlap with a region which corresponds to the detected facial region in the first image.

In a seventh aspect of the present invention, there is provided an image processing method comprising the steps of: accepting input or selection of a first image; detecting edges from the first image; and generating a second image by converting colors of pixels which correspond to the detected edges into a particular first color in the first image.

In an eighth aspect of the present invention, there is provided an image processing method comprising the steps of: accepting input or selection of a first image; detecting pixels whose brightness is lower than a particular threshold out of pixels in the first image; and generating a second image by converting colors of pixels which correspond to the detected pixels into a particular first color in the first image.

In a ninth aspect of the present invention, there is provided a program for causing a computer to execute an image processing method, the method comprising the steps of: accepting input or selection of a first image; detecting edges from the first image; and generating a second image by converting colors of pixels which correspond to the detected edges into a particular first color in the first image.

In a tenth aspect of the present invention, there is provided a program for causing a computer to execute an image processing method, the method comprising the steps of: accepting input or selection of a first image; detecting pixels whose brightness is lower than a particular threshold out of pixels in the first image; and generating a second image by converting colors of pixels which correspond to the detected pixels into a particular first color in the first image.

In an eleventh aspect of the present invention, there is provided a computer-readable recording medium recording a program for causing a computer to execute an image processing method, the method comprising the steps of: accepting input or selection of a first image; detecting edges from the first image; and generating a second image by converting colors of pixels which correspond to the detected edges into a particular first color in the first image.

In a twelfth aspect of the present invention, there is provided a computer-readable recording medium recording a program for causing a computer to execute an image processing method, the method comprising the steps of: accepting input or selection of a first image; detecting pixels whose brightness is lower than a particular threshold out of pixels in the first image; and generating a second image by converting colors of pixels which correspond to the detected pixels into a particular first color in the first image.

The above configurations make it possible to detect particular regions from an image.

Also, they make it possible to lay out an object on an image in such a way that the object will not overlap with particular regions.

Also, they make it possible to lay out an object on an image in such a way that the object will be oriented properly with respect to the image.

Also, they make it possible to detect particular regions properly from an image.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a diagram showing an example of an image;

FIG. 2 is a diagram showing an example of an image on which text is laid out;

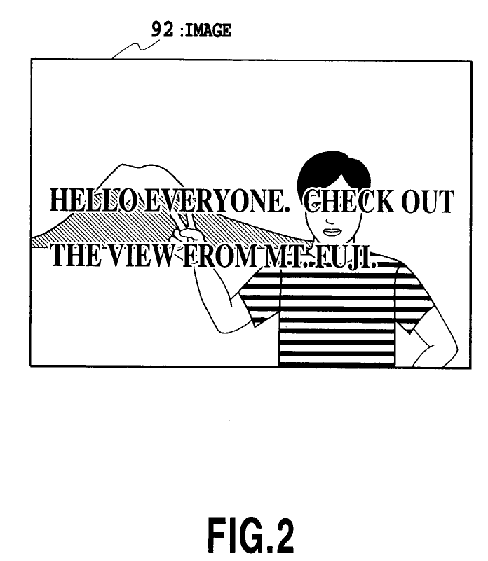

FIG. 3 is a diagram showing an example of an image;

FIG. 4 is a diagram showing an example of how a facial region is detected from the image in FIG. 3;

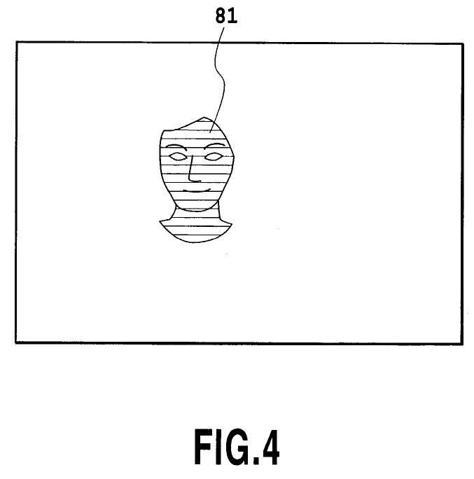

FIG. 5 is a diagram showing an example of how a facial region is detected from the image in FIG. 3;

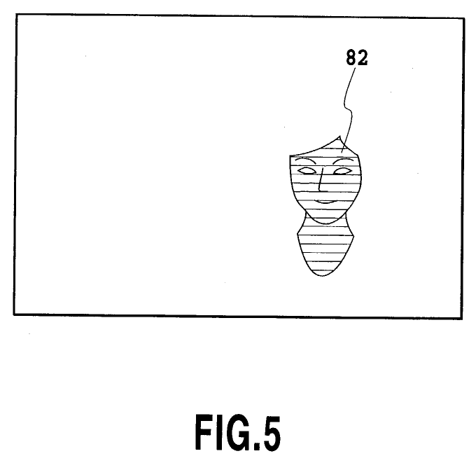

FIG. 6 is a diagram showing an example of how a facial region is detected from the image in FIG. 3;

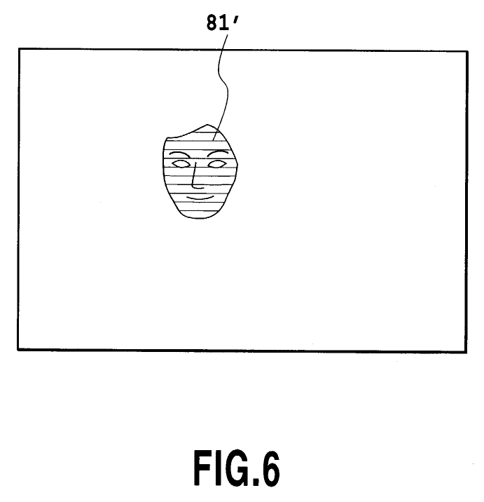

FIG. 7 is a diagram showing a configuration example of an image processing apparatus according to a first embodiment of the present invention;

FIG. 8 is a diagram showing functions of the image processing apparatus according to the first embodiment of the present invention;

FIG. 9 is a flowchart showing an example of image processing according to the first embodiment of the present invention;

FIG. 10 is a diagram showing an example of how skin-colored regions are detected from the image in FIG. 1;

FIG. 11 is a diagram showing an example of how regions larger than a particular size are detected from among the regions in FIG. 10;

FIG. 12 is a diagram showing an example of how a holed region is detected from among the regions in FIG. 11;

FIG. 13 is a diagram showing an example of a mask image;

FIG. 14 is a diagram showing an example of an image on which an object is laid out;

FIG. 15 is a diagram showing a configuration example of an image processing apparatus according to a second embodiment of the present invention;

FIG. 16 is a diagram showing functions of the image processing apparatus according to the second embodiment of the present invention;

FIG. 17 is a flowchart showing an example of image processing according to the second embodiment of the present invention;

FIG. 18 is a diagram showing an example of a temporary image generated from the image in FIG. 3;

FIG. 19 is a diagram showing an example of how the image in FIG. 3 is converted into a grayscale image and its edges are detected;

FIG. 20 is a diagram showing functions of an image processing apparatus according to a third embodiment of the present invention;

FIG. 21 is a flowchart showing an example of image processing according to the third embodiment of the present invention;

FIG. 22 is a diagram showing how the image in FIG. 3 is converted into a grayscale image and pixels whose brightness is lower than a particular threshold are detected;

FIG. 23 is a diagram showing an image obtained by masking the temporary image shown in FIG. 18 by a solidly shaded area in FIG. 22; and

FIG. 24 is a diagram showing an application example of the image processing apparatus.

### DETAILED DESCRIPTION OF PREFERRED EMBODIMENTS

Embodiments of the present invention will be described below with reference to the drawings.

### First Embodiment

An image processing apparatus according to a first embodiment of the present invention processes a received image to detect a facial region. As a feature for detecting a facial region, skin color is used primarily. Out of image areas which are colored like skin, regions most likely to be faces are separated from other regions such as other skin regions and background images colored like skin. Detectable features which can be used to distinguish facial regions from other skin-colored regions include shapes as well as regions which appear to be holes attributable to eyes and a mouth. Edge detection can be used to locate the “holes” in facial regions and detect the overall contours of faces. A mask image is generated based on information about the locations and contours of the facial regions. The mask image, i.e., the information about the locations and contours of the facial regions are passed to a layout manager together with the original image. This allows the layout manager to lay out text, graphics, and other images in such a way that they will not overlap with the facial regions. The image processing apparatus according to this embodiment uses a relatively simple face detection technique for these purposes.

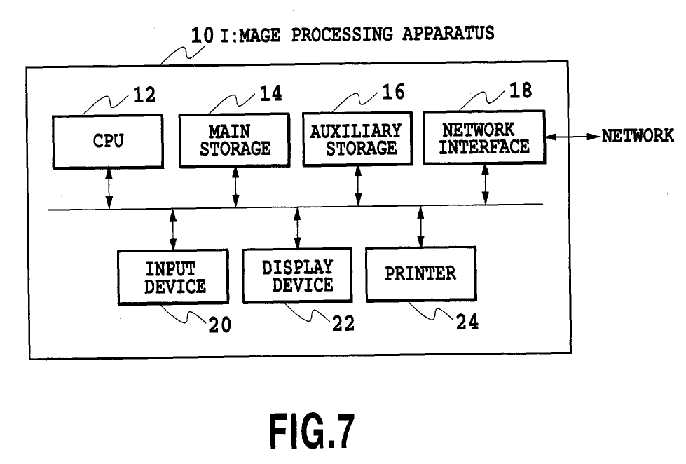

FIG. 7 is a diagram showing a configuration example of the image processing apparatus according to this embodiment. The image processing apparatus 10 shown in FIG. 7 may take the form of a personal computer, workstation, or the like. It comprises a CPU (central processing unit) 12, main storage 14, auxiliary storage 16, network interface 18, input device 20, display device 22 and printer 24.

The CPU 12, which may take the form of a microprocessor, performs various types of control for the image processing apparatus 10. The main storage 14, which consists of a RAM, ROM, or the like, stores various programs and various data such as images. The auxiliary storage 16, which may take the form of a hard disk, floppy disk, optical disk, or the like, stores various programs and various data such as images. The input device 20 consists of a keyboard, mouse, etc. The display device 22 is used to display images and the like. The printer 24 is used to print images and the like.

The CPU 12 performs processing based on control programs such as an OS (Operating System) as well as on image processing programs stored in the main storage 14. According to this embodiment, a user interface 32, skin-colored region detector 34, size-based region detector 36, holed-region detector 38, mask image generator 40, and image orientation detector 42 are implemented by software (programs). However, all or part of them may be implemented by hardware. These programs and data (data in an image/object database 52, etc.) may be stored in the main storage 14, hard disk, or the like in advance or may be stored on a floppy disk, CD-ROM, optical disk, or the like and read into the main storage 14, hard disk, or the like before their execution.

The image processing apparatus 10 can communicate with other devices via the network interface 18 and a network. The image processing apparatus 10 can communicate with another terminal based, for example, on HTTP (Hyper Text Transfer Protocol), allowing the user at the other terminal to input or select various data and receive resulting images on Web pages of the image processing apparatus 10.

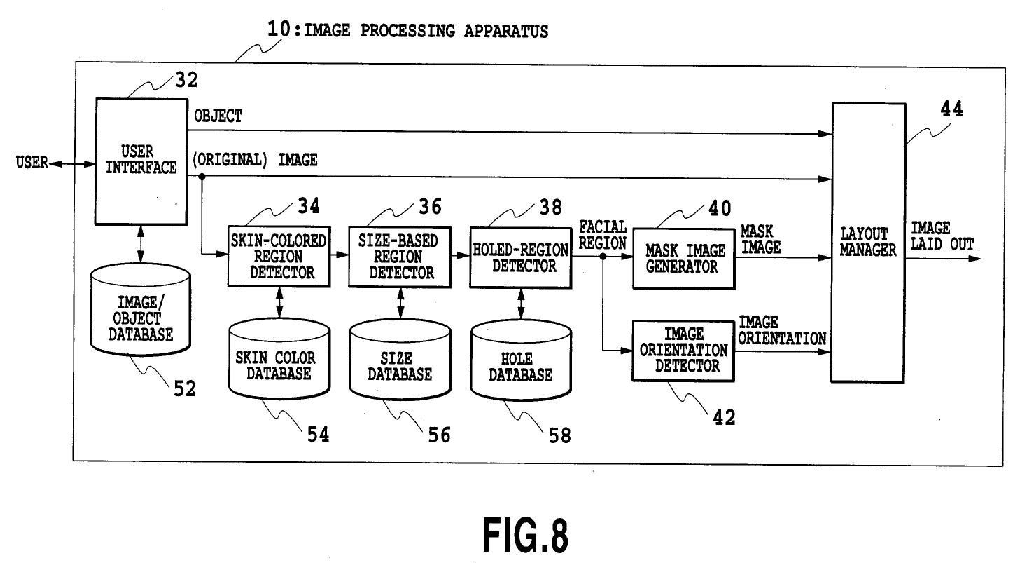

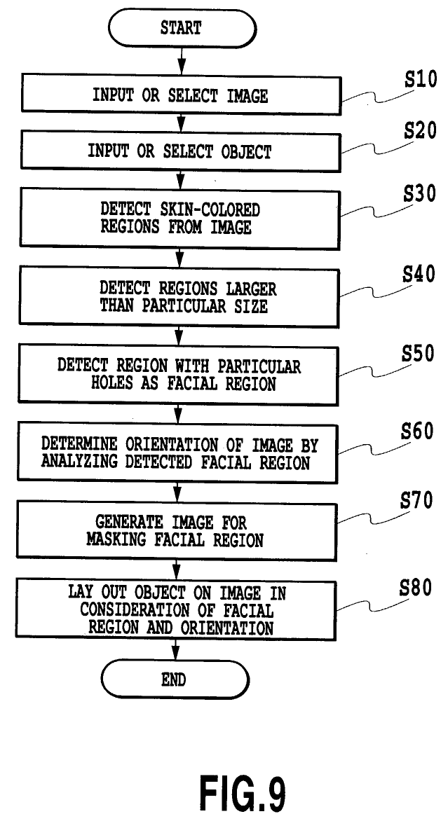

FIG. 8 is a diagram showing functions of the image processing apparatus according to this embodiment. FIG. 9 is a flowchart showing an example of image processing according to this embodiment.

First, via the user interface 32, the user can input or select an (original) image as well as an object (text, graphic, another image, etc.) to be laid out on the original image (Steps S10 and S20 in FIG. 9).

The user interface 32 allows the user to input or select images and objects easily via the input device 20 by watching the display device 22.

In order for the user to select an image, for example, images stored in the image/object database 52 may be presented on the display device 22 or the user may be allowed to input an image owned by him/her via a floppy disk or the like.

Regarding the object, similarly, the user may be allowed to select objects stored in the image/object database 52 or to input his/her own object.

The image may be, for example, a colored digital still image. It may be provided as a file in a typical still image format such as BMP (Bitmap) or JPEG. The image processing apparatus 10 may convert file formats to simplify image handling and processing.

The skin-colored region detector 34 detects skin-colored regions from the image using data from a skin color database 54 (Step S30).

Each pixel in the image has a color and each pixel color is compared with the data (skin color) from the skin color database 54. The data in the skin color database 54 can be prepared, for example, by collecting colored digital still images with skin tones under different lighting conditions. Also, study findings about skin colors made available so far can be used as data.

The pixels judged to be skin-colored as a result of the comparison are copied to a temporary image. The resulting temporary image contains only skin-colored pixels. Thus, skin-colored regions are formed in the temporary image.

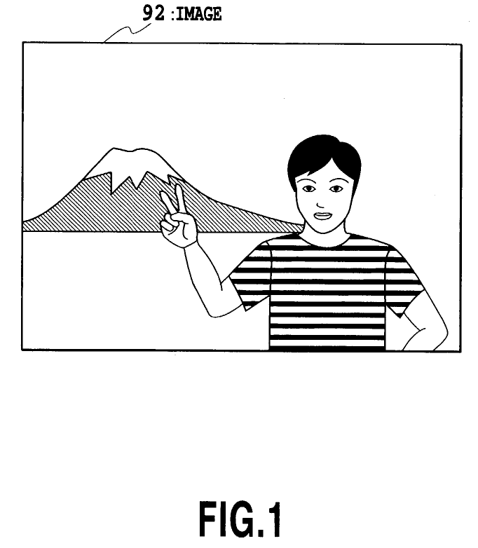

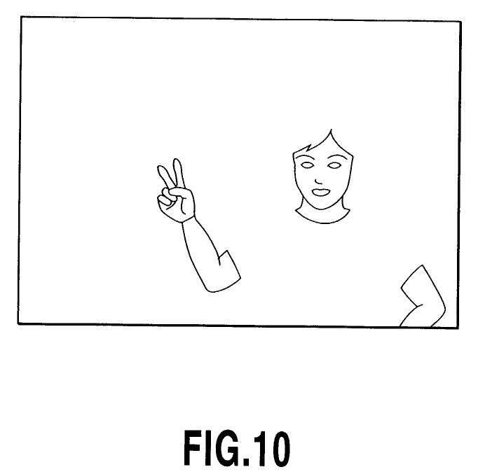

FIG. 10 is a diagram showing an example of how skin-colored regions are detected from an image 92 in FIG. 1. In the example of FIG. 10, a facial region, a neck region, arm regions, and a hand region are detected.

Then, the size-based region detector 36 detects regions larger than a particular size out of the detected skin-colored regions using data from a size database 56 (Step S40).

According to this embodiment, the size of the detected skin-colored regions relative to the overall image is compared with a predetermined threshold (data of the size database 56). Only the regions larger than the threshold are retained and the regions smaller than the threshold are removed from the temporary image.

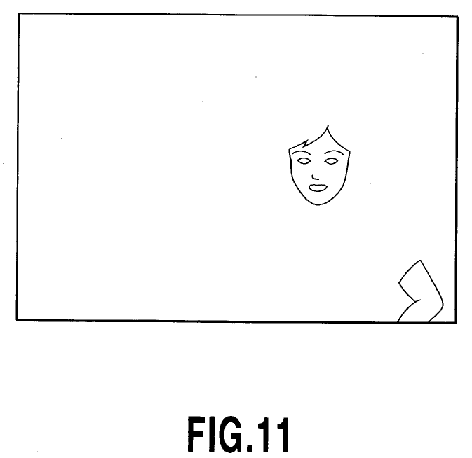

FIG. 11 is a diagram showing an example of how regions larger than a particular size are detected from among the regions in FIG. 10. In the example of FIG. 11, a facial region and arm regions are detected, and the other regions are removed.

Then, from among the detected regions larger than the particular size, the holed-region detector 38 detects a region which has particular holes, as a facial region, using data from a hole database 58 (Step S50).

The holed-region detector 38 checks candidate regions, i.e., the detected skin-colored regions larger than the particular size, for “holes”. In an image of a human face, sharp color changes are observed around the eyes, mouth, nose, and eyebrows. In an image which contains only skin-colored pixels, such regions appear as “holes” or empty spots surrounded by skin-colored pixels. By comparing the relative locations of these “holes” with expected patterns (data of the hole database 58) of a human face viewed from different positions and angles, a facial region can be recognized and distinguished from other skin-colored regions. Regarding patterns of human faces, in addition to frontal faces, profiles may be prepared.

Before checking for “holes”, the holed-region detector 38 performs edge detection on those regions in the original image which correspond to the candidate regions. This makes it possible to acquire clear boundaries of the candidate regions.

When checking for “holes”, the holed-region detector 38 judges whether a holed region in the original image corresponds to an eye or mouth. This judgment is made by checking whether the holed region in the original image is colored like an eye or mouth. This is because regions which correspond to eyes are highly likely to be white and regions which correspond to a mouth are highly likely to have dark red components. Eye and mouth color data is contained in the hole database 58. The use of this information makes it possible to eliminate candidate regions which have “holes”, but are not actually faces.

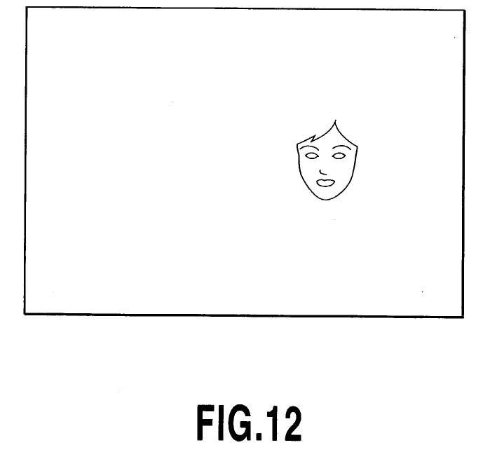

FIG. 12 is a diagram showing an example of how a holed region is detected from among the regions in FIG. 11. In the example of FIG. 12, the facial region has been detected and the arm regions have been removed.

Then, the image orientation detector 42 determines the orientation of the (original) image by analyzing the detected facial region (Step S60).

The orientation (which side is up, etc.) of an image can be determined by analyzing the relative locations of “holes” in the facial region and taking into consideration other general characteristics of faces including the fact that faces are generally longer in the vertical direction than in the horizontal direction. If a number of facial regions are detected in an image, the orientation of the image is determined, for example, by equally weighting the facial regions.

Then, the mask image generator 40 generates an image for masking the detected facial region (Step S70).

According to this embodiment, the mask image is a binary image of the same height and width as the original image. “1” pixels in the mask image indicate that a facial region exists in the corresponding pixel locations of the original image. Thus, the pixel at position (x, y) in the binary mask image is set to “1” if the pixel at position (x, y) in the original image falls within a facial region. The pixels regarded to be part of a facial region include the skin-colored pixels in the facial region and pixels of “holes” in the facial region.

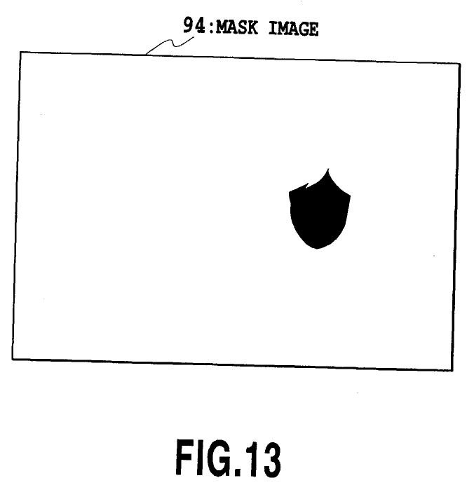

FIG. 13 is a diagram showing an example of a mask image (mask image 94).

Next, the layout manager 44 lays out the object on the image in consideration of the facial region and the orientation (Step S80).

Specifically, the layout manager 44 receives the original image, object, mask image, and image orientation and lays out the object on the original image in such a way that the object will not overlap with the facial region and that the object will be oriented properly with respect to the original image.

The image on which the object has been laid out is presented to the user via the display device 22, printer 24, the network interface 18, or the like.

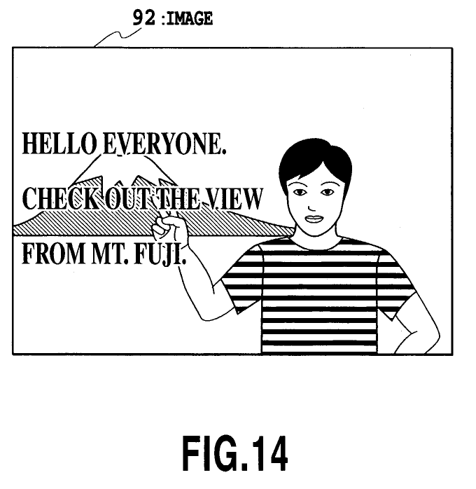

FIG. 14 is a diagram showing an example of an image on which an object is laid out. In the example of FIG. 14, text reading “Hello everyone. Check out the view from Mt. Fuji” is laid out on the image 92. In the resulting image, the text does not overlap with the facial region and the text is oriented properly with respect to the image 92.

Although detection of a facial region has been cited as an example in this embodiment, the present invention can also be applied to detection of other particular regions (e.g., a region where there is someone, hairy region, sky region, or region of a particular color).

### Second Embodiment

An image processing apparatus according to a second embodiment of the present invention processes a received image to detect facial regions. As a feature for detecting facial regions, skin color is used primarily. Out of image areas which are colored like skin, regions most likely to be faces are separated from other regions such as other skin regions and background images colored like skin. Detectable features which can be used to distinguish facial regions from other skin-colored regions include shapes as well as regions which appear to be holes attributable to eyes and a mouth. Edge detection and grayscale threshold techniques can be used to locate the “holes” in skin-colored regions. Based on information about the relative locations of dark regions, it is possible to determine the possibility that the dark regions correspond to the eyes, nose, mouse, etc. on a face. In this way, regions most likely to be faces can be detected.

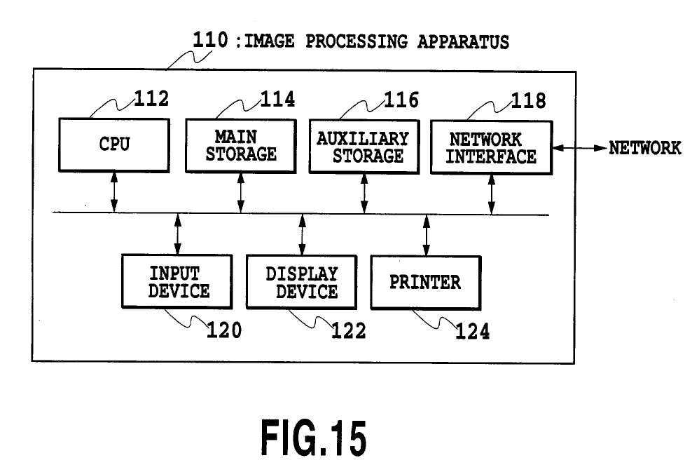

FIG. 15 is a diagram showing a configuration example of the image processing apparatus according to this embodiment of the present invention. The image processing apparatus 110 shown in FIG. 15 may take the form of a personal computer, workstation, or the like. It comprises a CPU (central processing unit) 112, main storage 114, auxiliary storage 116, network interface 118, input device 120, display device 122 and printer 124.

The CPU 112, which may take the form of a microprocessor, performs various types of control for the image processing apparatus 110. The main storage 114, which consists of a RAM, ROM, or the like stores various programs and various data such as images. The auxiliary storage 116, which may take the form of a hard disk, floppy disk, optical disk, or the like, stores various programs and various data such as images. The input device 120 consists of a keyboard, mouse, etc. The display device 122 is used to display images and the like. The printer 124 is used to print images and the like.

The CPU 112 performs processing based on control programs such as an OS (Operating System) as well as on image processing programs stored in the main storage 114. According to this embodiment, a user interface 132, skin-colored pixel detector 134, grayscale converter 136, edge detector 138, mask processor 140, region creator 142, facial-region detector 144, and layout manager 146 are implemented by software (programs). However, all or part of them may be implemented by hardware. These programs and data (data in an image/object database 152, etc.) may be stored in the main storage 114, hard disk, or the like in advance or may be stored on a floppy disk, CD-ROM, optical disk, or the like and read into the main storage 114, hard disk, or the like before their execution.

The image processing apparatus 110 can communicate with other devices via the network interface 118 and a network. The image processing apparatus 110 can communicate with another terminal based, for example, on HTTP (Hyper Text Transfer Protocol), allowing the user at the other terminal to input or select various data and receive resulting images on Web pages of the image processing apparatus 110. Also, e-mail may be used for input and selection of various data and transmission of images.

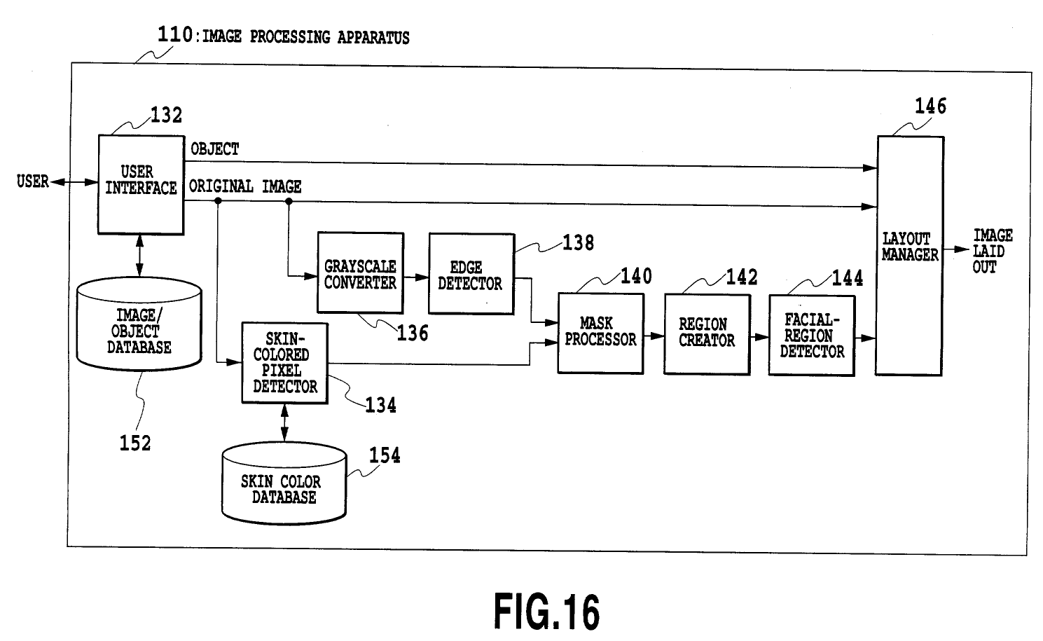

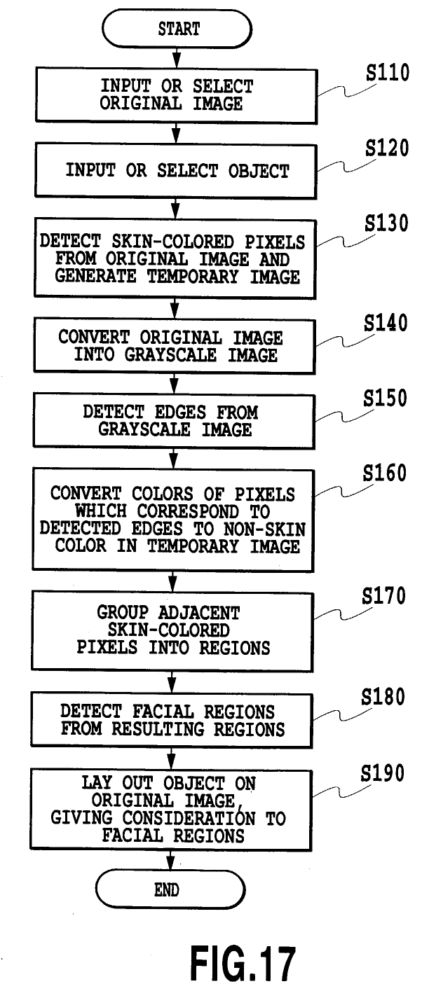

FIG. 16 is a diagram showing functions of the image processing apparatus according to this embodiment. FIG. 17 is a flowchart showing an example of image processing according to this embodiment.

First, via the user interface 132, the user can input or select an original image (image to be subjected to image processing) as well as an object (text, graphic, another image, etc.) to be laid out on the original image (Steps S110 and S120 in FIG. 17).

The user interface 132 allows the user to input or select original images and objects easily via the input device 120 by watching the display device 122.

In order for the user to select an original image, images stored in the image/object database 152 may be presented on the display device 122 or the user may be allowed to input an image owned by him/her via a floppy disk or the like.

Regarding the object, similarly, the user may be allowed to select from objects stored in the image/object database 152 or to input his/her own object.

The image may be, for example, a colored digital still image. It may be provided as a file in a typical still image format such as BMP (Bitmap) or JPEG. The image processing apparatus 110 may convert file formats to simplify image handling and processing.

Then, the skin-colored pixel detector 134 detects skin-colored pixels from the original image using data from a skin color database 154 (Step S130).

Each pixel in the original image has a color and each pixel color is compared with the data (skin color) from the skin color database 154. The data in the skin color database 154 can be prepared, for example, by collecting colored digital still images with skin tones under different lighting conditions. Also, study findings about skin colors made available so far can be used as data.

The pixels judged to be skin-colored as a result of the comparison are copied to a temporary image. This results in the temporary image consisting of skin-colored pixels.

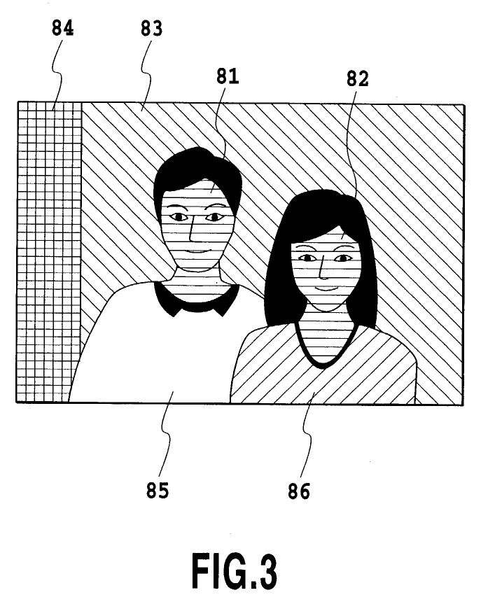

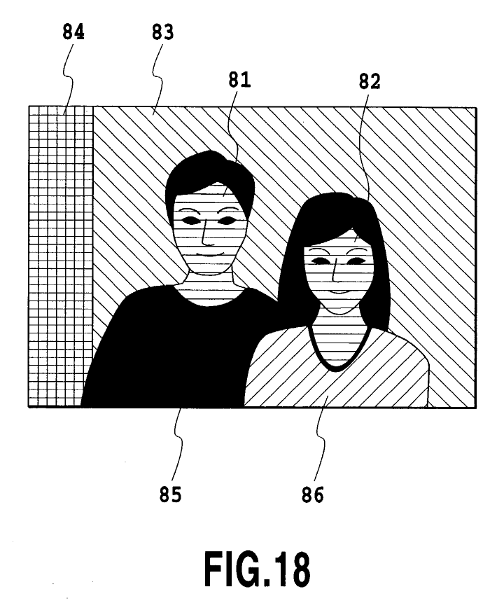

FIG. 18 is a diagram showing an example of a temporary image generated from the image in FIG. 3. In FIG. 18, areas other than the solidly shaded areas represent the detected pixels, i.e., pixels judged to be skin-colored. In the example of FIG. 18, the range of the skin color has been made to be rather wide. Pixels in the facial regions 81 and 82, pixels in the background regions 83 and 84, and pixels in the clothing region 86 excluding the collar are detected.

Then, the grayscale converter 136 converts the original image (e.g., RGB (red-green-blue) image) into a grayscale image (Step S140). Then, the edge detector 138 detects edges from the grayscale image (Step S150). Incidentally, if the original image is a grayscale image, no conversion is necessary. Besides, it is also possible to detect edges from the original image without converting it into a grayscale image.

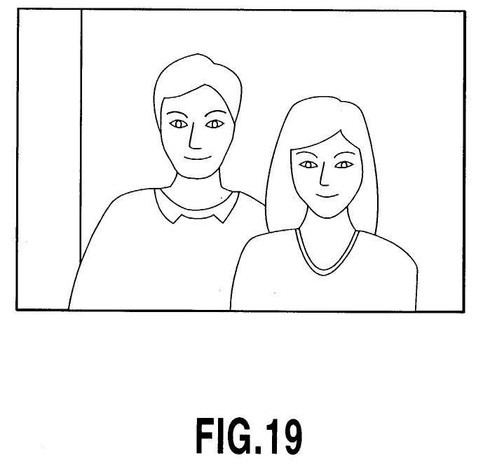

FIG. 19 is a diagram showing an example of how the image in FIG. 3 is converted into a grayscale image and its edges are detected.

Then, the mask processor 140 converts the colors of the pixels which correspond to the detected edges in the temporary image (e.g., FIG. 18) generated in Step S130 to anon-skin color (e.g., black) (Step S160). Specifically, it performs a process like masking the temporary image shown in FIG. 18 with the edges shown in FIG. 19. The resulting image is similar to the temporary image shown in FIG. 18, but has clearer boundaries between skin-colored or nearly skin-colored regions than does the temporary image, making it easier to detect facial regions.

Incidentally, the mask processor 140 may convert the colors of the pixels which correspond to the detected edges to a non-skin color in the original image instead of the temporary image. Then, skin-colored pixels may be detected in the resulting image.

In the image produced by the mask processor 140, the region creator 142 groups adjacent skin-colored pixels into regions (Step S170). Then, the facial-region detector 144 detects facial regions from the resulting regions (candidate regions) (Step S180).

For example, from an image obtained by applying the masking process to the temporary image shown in FIG. 18, the facial region 81, facial region 82, background region 83, background region 84, and clothing region 86 excluding the collar can be obtained. The facial region 81 and facial region 82 are detected from these candidate regions.

Facial regions are detected as follows, for example. First, candidate regions are searched for those containing dark regions. The relative locations of the dark regions are analyzed. Then, the regions in which the dark regions nearly correspond to the positions of the eyebrows, eyes, nose, and mouth are detected as facial regions.

The facial regions may be detected by taking into consideration the relative sizes of the dark regions. Also, those candidate regions which contain a smaller number of dark regions which can correspond to the eyebrows, eyes, nose, and mouth may be selected preferentially as facial regions.

Then, the layout manager 146 lays out the object on the original image, giving consideration to the facial regions (Step S190). Specifically, it lays out the object on the original image in such a way that the object will not overlap with the facial regions in the original image (the facial regions have been detected in Step S180).

The original image on which the object has been laid out is output and presented to the user via the display device 122, printer 124, the network interface 118, or the like.

### Third Embodiment

In a third embodiment of the present invention, a masking process is applied to detected pixels whose brightness is lower than a particular threshold whereas a masking process has been applied to detected edges according to the second embodiment. A configuration example of an image processing apparatus according to this embodiment is the same as that shown in FIG. 15.

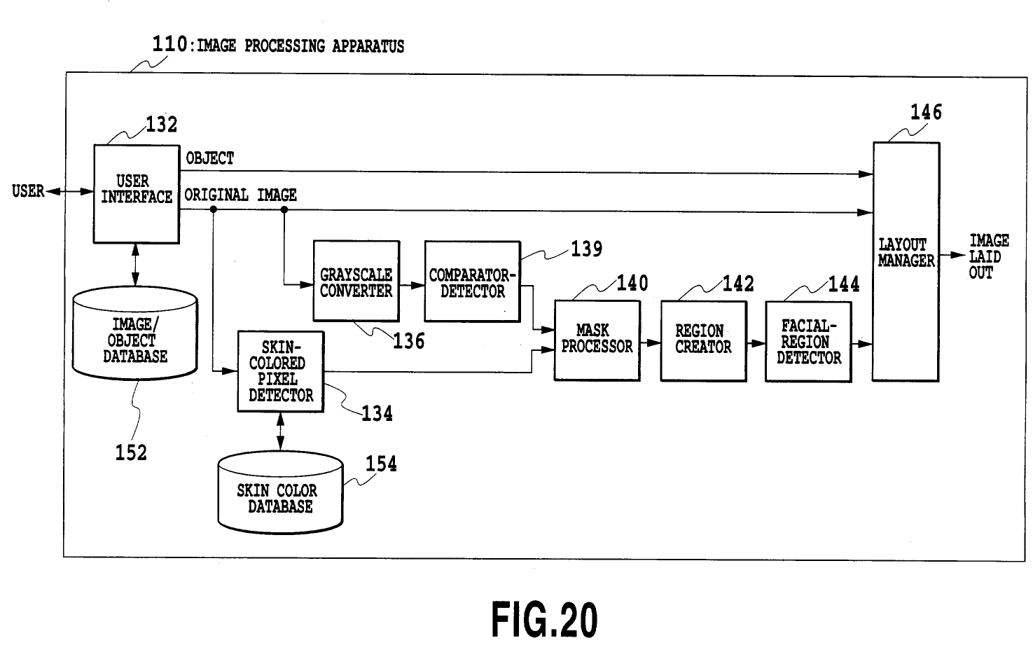

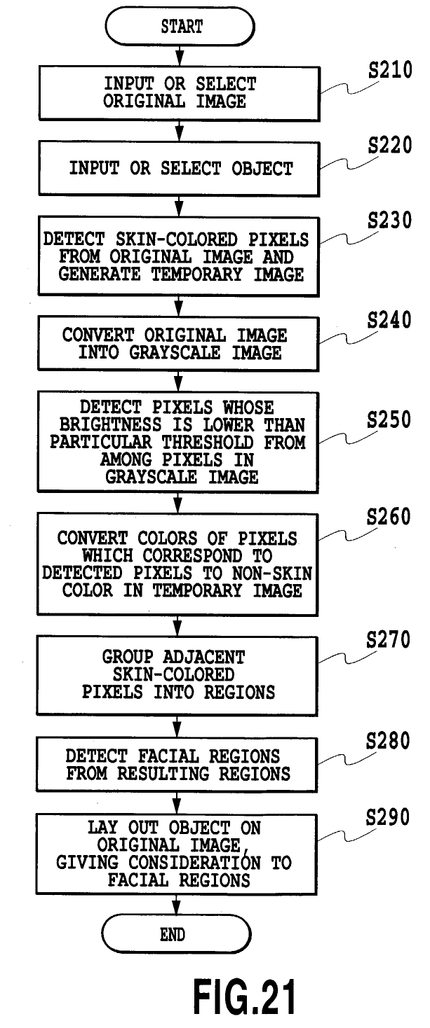

FIG. 20 is a diagram showing functions of the image processing apparatus according to this embodiment. FIG. 21 is a flowchart showing an example of image processing according to this embodiment.

A comparator-detector 139, which is implemented by software, has capabilities to detect pixels whose brightness is lower than a particular threshold.

In FIG. 21, Steps S210 to S240 are the same as Steps S11O to S140 in the second embodiment.

In Step S250, the comparator-detector 139 detects pixels whose brightness is lower than the particular threshold from among the pixels in the grayscale image. Specifically, it compares the brightness of every pixel in the grayscale image with the threshold and determines whether it is above or below the threshold.

The threshold can be established, for example, such that 30% of all the pixels will have brightness lower than the threshold, after creating a histogram of brightness of all the pixels in the image.

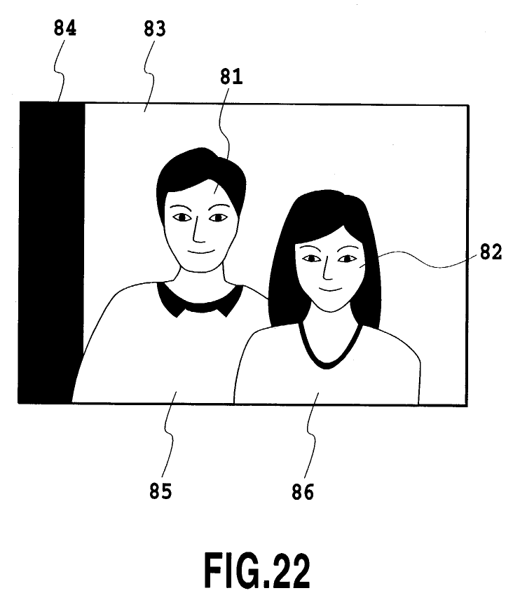

FIG. 22 is a diagram showing how the image in FIG. 3 is converted into a grayscale image and how pixels whose brightness is lower than a particular threshold are detected. In FIG. 22, the solidly shaded areas represent the detected pixels. In the example of FIG. 22, the pixels in the facial regions 81 and 82, background region 83, clothing region 85 excluding the collar, and clothing region 86 excluding the collar have brightness higher than the threshold while the pixels in the background region 84 have brightness lower than the threshold.

In Step S250, the pixels whose brightness is lower than the particular threshold may be detected from the original image instead of the grayscale image.

In Step S260, the mask processor 140 converts the colors of the pixels which correspond to the pixels detected in Step S250 to a non-skin color (e.g., black) in the temporary image (e.g., FIG. 18) generated in Step S230. Specifically, it performs a process like masking the temporary image shown in FIG. 18 with the solidly shaded areas shown in FIG. 22.

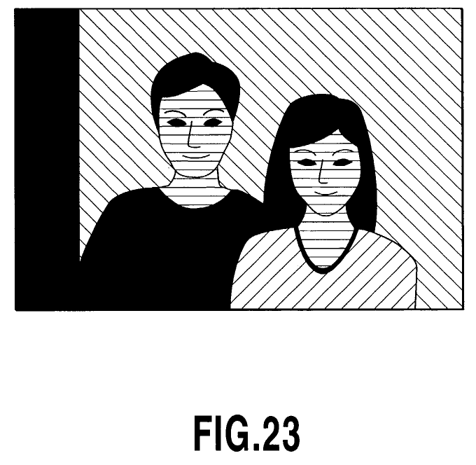

FIG. 23 is a diagram showing an image obtained by masking the temporary image shown in FIG. 18 by the solidly shaded area in FIG. 22.

The pixels around boundaries are likely to have low brightness, to be detected in Step S250, and to be converted into anon-skin color in Step S260. Thus, the image (e.g., FIG. 23) obtained as a result of masking has clearer boundaries between skin-colored or nearly skin-colored regions than does the temporary image (e.g., FIG. 18), making it easier to detect facial regions.

Incidentally, the mask processor 140 may convert the colors of the pixels which correspond to the pixels detected in Step S250 to a non-skin color in the original image instead of the temporary image. Then, skin-colored pixels may be detected in the resulting image.

In Step S270, the region creator 142 groups adjacent skin-colored pixels in the image produced by the mask processor 140 into regions. Steps S270 to S290 are the same as Steps S170 to S190 in the second embodiment, and thus the subsequent processes are the same as those in the second embodiment.

### Other

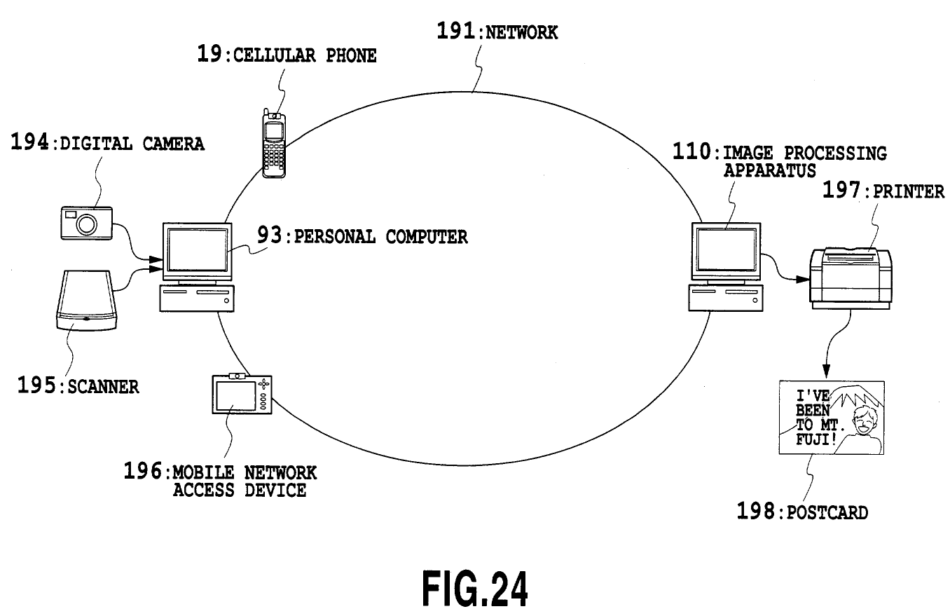

FIG. 24 is a diagram showing an application example of the image processing apparatus. A postcard print service system shown in FIG. 24 receives an object such as text and an original image from the user and creates an image by laying out the object automatically.

More specifically, the image processing apparatus 110 receives an object and original image from a user terminal (e.g., a cellular phone with a digital camera 192, personal computer 193 (capable of connecting with a digital camera 194 or scanner 195), or mobile network access device 196) via a network 191 (the Internet or the like). Then, it generates a desired image by laying out the object on the original image in such a way that the object will not overlap with facial regions in the original image. The generated image may be transmitted to the user terminal or printed on the printer 197. FIG. 24 shows a postcard 198 prepared by printing an image on the printer 197. The object (“I've been to Mt. Fuji!”) is not overlapping with the facial region of the original image on the postcard 198.

Incidentally, if the image processing apparatus 110 receives data such as a destination address and name of the postcard 198, these data can also be printed on the postcard 198. Once the operator of the image processing apparatus 110 puts the postcard 198 into a mailbox, the postcard 198 will be delivered to its destination.

Although either edges or pixels whose brightness is lower than a particular threshold are detected in the embodiments described above, it is possible to detect both of them. Then, a masking process can be performed for the detected edges and pixels.

Also, although detection of facial regions has been cited as an example in the above embodiments, the present invention can also be applied to detection of other particular regions (e.g., a region where there is someone, hairy region, sky region, or region of a particular color).

As described above, the present invention makes it possible to detect particular regions from an image.

Also, the present invention makes it possible to lay out an object on an image in such a way that the object will not overlap with particular regions.

Also, the present invention makes it possible to lay out an object on an image in such a way that the object will be oriented properly with respect to the image.

Also, the present invention makes it possible to detect particular regions properly from an image.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. An image processing apparatus comprising:
means for storing detection information for detecting a particular region from an image;
means for accepting input or selection of the image; and
means for detecting the particular region from the image using the detection information.

2. The image processing apparatus as claimed in claim 1, wherein the particular region is a facial region.

3. The image processing apparatus as claimed in claim 2, wherein the detection information includes information about a skin color and the means for detecting the particular region comprises means for detecting a skin-colored region from the image.

4. The image processing apparatus as claimed in claim 3, wherein the detection information includes information about a size and the means for detecting particular regions comprises means for detecting a region larger than a particular size from among skin-colored regions.

5. The image processing apparatus as claimed in claim 3, wherein the detection information includes information about holes and the means for detecting particular regions comprises means for detecting a region which has particular holes from among skin-colored regions.

6. The image processing apparatus as claimed in claim 5, wherein the means for detecting a region which has particular holes comprises means for performing edge detection.

7. The image processing apparatus as claimed in claim 5, wherein the detection information includes information about an eye or mouth color and the means for detecting a region which has particular holes comprises means for judging whether regions which correspond to the particular holes in the image have an eye or mouth color.

8. The image processing apparatus as claimed in claim 1, comprising means for analyzing the particular region and determining orientation of the image.

9. The image processing apparatus as claimed in claim 1, comprising means for generating an image which masks the particular region.

10. The image processing apparatus as claimed in claim 1, comprising means for accepting input or selection of an object, and means for laying out the object on the image in such a way that the object will not overlap with the particular region.

11. The image processing apparatus as claimed in claim 1, comprising means for analyzing the particular region and determining orientation of the image, means for accepting input or selection of an object, and means for laying out the object on the image in such a way that the object will be oriented properly with respect to the image.

12. An image processing method for an image processing apparatus which comprises means for storing detection information for detecting a particular region from an image, the method comprising the steps of:
accepting input or selection of the image; and
detecting the particular region from the image using the detection information.

13. A program for causing an image processing apparatus which comprises means for storing detection information for detecting a particular region from an image to execute an image processing method, the method comprising the steps of:
accepting input or selection of the image; and
detecting the particular region from the image using the detection information.

14. A computer-readable recording medium recording a program for causing an image processing apparatus which comprises means for storing detection information for detecting a particular region from an image to execute an image processing method, the method comprising the steps of:
accepting input or selection of the image; and
detecting the particular region from the image using the detection information.

15. An image processing apparatus comprising:
means for accepting input or selection of a first image;
means for detecting edges from the first image; and
means for generating a second image by converting colors of pixels which correspond to the detected edges into a particular first color in the first image.

16. The image processing apparatus as claimed in claim 15, further comprising means for converting the first image into a third image in grayscale, wherein the means for detecting detects edges from the third image.

17. The image processing apparatus as claimed in claim 15, further comprising means for detecting pixels which have a particular second color from the first image and generating a fourth image composed of the detected pixels, wherein the means for generating the second image generates the second image by converting colors of pixels which correspond to the detected edges into the first color in the fourth image.

18. The image processing apparatus as claimed in claim 17, wherein the second color is a skin color and the first color is a color other than the skin color.

19. The image processing apparatus as claimed in claim 15, further comprising means for detecting a facial region from the second image.

20. The image processing apparatus as claimed in claim 19, further comprising means for accepting input or selection of an object, and means for laying out the object on the first image in such a way that the object will not overlap with a region which corresponds to the detected facial region in the first image.

21. An image processing apparatus comprising:
means for accepting input or selection of a first image;
means for detecting pixels whose brightness is lower than a particular threshold out of pixels in the first image; and
means for generating a second image by converting colors of pixels which correspond to the detected pixels into a particular first color in the first image.

22. The image processing apparatus as claimed in claim 21, further comprising means for converting the first image into a third image in grayscale, wherein the means for detecting detects pixels whose brightness is lower than the threshold out of pixels in the third image.

23. The image processing apparatus as claimed in claim 21, further comprising means for detecting pixels which have a particular second color from the first image and generating a fourth image composed of the detected pixels, wherein the means for generating the second image generates the second image by converting colors of pixels which correspond to the detected pixels into the first color in the fourth image.

24. The image processing apparatus as claimed in claim 23, wherein the second color is a skin color and the first color is a color other than the skin color.

25. The image processing apparatus as claimed in claim 21, further comprising means for detecting a facial region from the second image.

26. The image processing apparatus as claimed in claim 25, further comprising means for accepting input or selection of an object, and means for laying out the object on the first image in such a way that the object will not overlap with a region which corresponds to the detected facial region in the first image.

27. An image processing method comprising the steps of:
accepting input or selection of a first image;
detecting edges from the first image; and
generating a second image by converting colors of pixels which correspond to the detected edges into a particular first color in the first image.

28. An image processing method comprising the steps of:
accepting input or selection of a first image;
detecting pixels whose brightness is lower than a particular threshold out of pixels in the first image; and
generating a second image by converting colors of pixels which correspond to the detected pixels into a particular first color in the first image.

29. A program for causing a computer to execute an image processing method, the method comprising the steps of:
accepting input or selection of a first image;
detecting edges from the first image; and
generating a second image by converting colors of pixels which correspond to the detected edges into a particular first color in the first image.

30. A program for causing a computer to execute an image processing method, the method comprising the steps of:
accepting input or selection of a first image;
detecting pixels whose brightness is lower than a particular threshold out of pixels in the first image; and
generating a second image by converting colors of pixels which correspond to the detected pixels into a particular first color in the first image.

31. A computer-readable recording medium recording a program for causing a computer to execute an image processing method, the method comprising the steps of:
accepting input or selection of a first image;
detecting edges from the first image; and
generating a second image by converting colors of pixels which correspond to the detected edges into a particular first color in the first image.

32. A computer-readable recording medium recording a program for causing a computer to execute an image processing method, the method comprising the steps of:
accepting input or selection of a first image;
detecting pixels whose brightness is lower than a particular threshold out of pixels in the first image; and
generating a second image by converting colors of pixels which correspond to the detected pixels into a particular first color in the first image.
